(19) United States
(12) Patent Application Publication
(10) Pub. No.: US 2022/0042746 A1
(43) Pub. Date: Feb. 10, 2022

(54) HEAT EXCHANGER

(71) Applicant: DENSO CORPORATION, Kariya-city (JP)

(72) Inventors: Masanobu IIO, Kariya-city (JP); Shinichiro TAKISE, Kariya-city (JP)

(21) Appl. No.: 17/509,301

(22) Filed: Oct. 25, 2021

Related U.S. Application Data
(63) Continuation of application No. PCT/JP2020/019749, filed on May 19, 2020.

(30) Foreign Application Priority Data
May 29, 2019 (JP) 2019-100338

(51) Int. Cl. F28D 7/16; F28F 9/02

(52) U.S. Cl. CPC F28D 7/16; F28F 9/02

(57) ABSTRACT

A heat exchanger includes tubes, a pair of tanks, and a connector. The tubes are stacked with each other in a stacking direction. The pair of tanks are disposed at both ends of the tubes and a longitudinal direction of the tanks extends along the stacking direction. At least one of the tanks is a connecting tank. The connector is disposed in a side portion of the connecting tank to fluidly connect a pipe to the connecting tank. The connecting tank has a tubular shape and includes a flat surface on the side portion. The connector includes a facing surface facing the flat surface. The facing surface is joined to the flat surface such that at least a portion of the facing surface extends beyond the flat surface in a lateral direction of the connecting tank.

### CROSS REFERENCE TO RELATED APPLICATIONS

The present application is a continuation application of International Patent Application No. PCT/JP2020/019749 filed on May 19, 2020, which designated the U.S. and claims the benefit of priority from Japanese Patent Application No. 2019-100338 filed on May 29, 2019. The entire disclosures of all of the above applications are incorporated herein by reference.

### TECHNICAL FIELD

The present disclosure relates to a heat exchanger.

### BACKGROUND ART

A heat exchanger mounted in an automobile or the like has been known. The heat exchanger includes a header tank having a curved side portion and a part of the side portion is formed to have a flat surface. A connector connecting a pipe to the header tank is connected to the flat surface.

### SUMMARY

A heat exchanger includes multiple tubes stacked with each other in a stacking direction, a pair of tanks disposed at both ends of the multiple tubes, and a connector. Each of the pair of tanks has a longitudinal direction along the stacking direction and one of the pair of tanks is a connecting tank. The connector is disposed in a side portion of the connecting tank to fluidly connect a pipe to the connecting tank. The connecting tank has a tubular shape and includes a flat surface on the side portion. The connector includes a facing surface facing the flat surface. The facing surface of the connector is connected to the flat surface such that a portion of the facing surface extends beyond the flat surface in a lateral direction of the connecting tank. The connector has a tubular shape having a center axis that is perpendicular to the facing surface. The connector defines an opening at an opposite side that is opposite to the facing surface.

### BRIEF DESCRIPTION OF DRAWINGS

FIG. 1 is a diagram illustrating a configuration example of a heat exchanger according to a first embodiment of the present disclosure.

FIG. 2 is a diagram illustrating a joint configuration between a tank and a connector shown in FIG. 1.

FIG. 3 is a cross-sectional view taken along a line III-III in FIG. 2.

FIG. 4 is a partially enlarged view of the cross-sectional view shown in FIG. 3.

FIG. 5 is a diagram illustrating the joint configuration between the tank and the connector shown in FIG. 1.

FIG. 6 is a diagram illustrating a joint configuration between a tank and a connector in a heat exchanger of a comparative example.

FIG. 7 is a diagram illustrating a joint configuration between a tank and a connector in a heat exchanger of a modification from the first embodiment of the present disclosure.

FIG. 8 is a cross-sectional view illustrating a joint configuration between a tank and a connector in a heat exchanger of another modification from the first embodiment of the present disclosure.

### DESCRIPTION OF EMBODIMENTS

To begin with, examples of relevant techniques will be described.

A heat exchanger mounted in an automobile or the like has been known. The heat exchanger includes a header tank having a curved side portion and a part of the side portion is formed to have a flat surface. A connector connecting a pipe to the header tank is connected to the flat surface. When a high-temperature and high-pressure refrigerant is supplied into the heat exchanger, a pressure is applied to the header tank from an inside of the header tank, so that the flat surface of the header tank is likely to be deformed outward. Thus, stress is concentrated on an edge of a connecting portion between the connector and the header tank. When the heat exchange is repeatedly used, the header tank may be damaged from a portion where stress is concentrated.

To overcome such stress concentration, for example, a reinforcing plate is inserted between the flat surface of the header tank and the connector and an entire area of the reinforcing plate is brazed to the flat surface to restrict deformation of the flat surface.

Since the reinforcing plate is used to reinforce the header tank, more parts than necessary are required and the number of work steps is increased.

It is an object of the present disclosure to provide a heat exchanger that reduces stress concentration in a tank with a relatively simple configuration.

A heat exchanger according to one aspect of the present disclosure includes multiple tubes stacked with each other in a stacking direction, a pair of tanks disposed at both ends of the multiple tubes, and a connector. Each of the pair of tanks has a longitudinal direction along the stacking direction and one of the pair of tanks is a connecting tank. The connector is disposed in a side portion of the connecting tank to fluidly connect a pipe to the connecting tank. The connecting tank has a tubular shape and includes a flat surface on the side portion. The connector includes a facing surface facing the flat surface. The facing surface of the connector is connected to the flat surface such that a portion of the facing surface extends beyond the flat surface in a lateral direction of the connecting tank.

In the present disclosure, in a connection between the connector and the connecting tank, a part of the facing surface of the connector that faces the flat surface of the connecting tank extends beyond the flat surface. Thus, when a pressure is applied to an inner side of the connecting tank, stress is applied along a line where an outer edge of the flat surface overlaps with the facing surface of the connector. That is, in the present disclosure, since the stress is dispersed linearly, the stress concentration is relaxed as compared with a configuration in which the facing surface of the connector does not extend beyond the flat surface of the connecting tank. In the present disclosure, stress concentration at a joint portion between the connecting tank and the connector can be reduced with a relatively simple configuration without increasing a thickness of the connecting tank or inserting a reinforcing plate between the connecting tank and the connector.

Hereinafter, the present embodiments will be described with reference to the attached drawings. In order to facilitate the ease of understanding, the same reference numerals are attached to the same constituent elements in each drawing where possible, and redundant explanations are omitted.

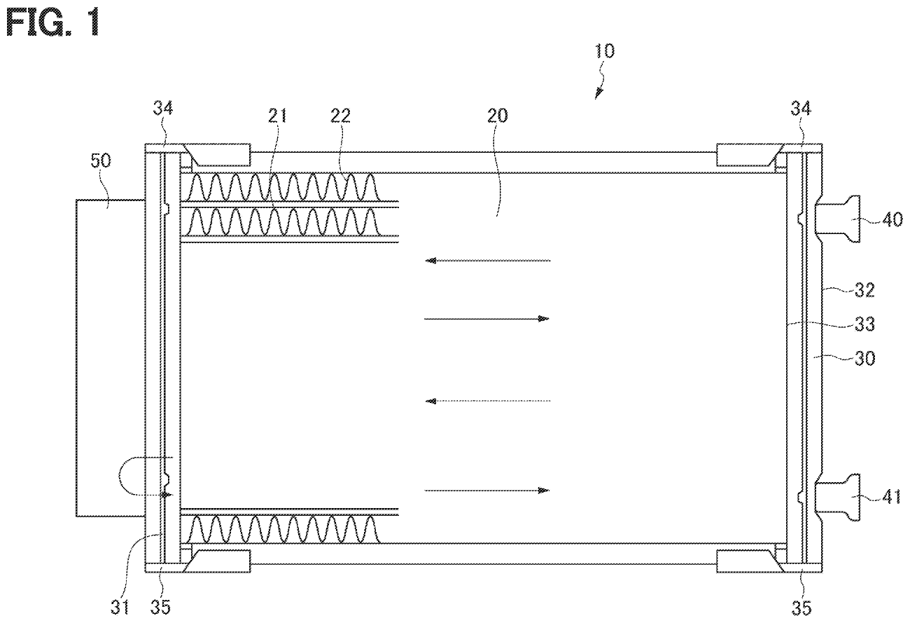

With reference to FIG. 1, a heat exchanger of a first embodiment will be described. The heat exchanger 10 is used as a condenser of an air-conditioner mounted in a moving body such as a vehicle. As shown in FIG. 1, the heat exchanger 10 includes, for example, a core portion 20, a pair of tanks 30, 31, connectors 40, 41, and a modulator tank 50. They are made of, for example, aluminum or aluminum alloy. They are temporarily fixed to each other by fitting, being deformed, jig, or the like, and then fixed to each other by brazing.

The core portion 20 includes multiple tubes 21 and multiple fins 22. Refrigerant flows inside the tubes 21. The fins 22 are corrugated and cool air flows through spaces around the fins 22. The tubes 21 and the fins 22 are alternately stacked and joined to each other.

The pair of tanks 30 and 31 are disposed at both ends of the core portion 20 in a flow direction in which the refrigerant flows through the tubes 21. The pair of tanks 30, 31 are so-called header tanks having a longitudinal direction along the direction in which the tubes 21 and the fins 22 are stacked with each other. The pair of tanks 30, 31 define therein multiple tube holes (not shown). An end of each of the tubes 21 is fit into the tube hole and joined such that the tubes 21 are fluidly in communication with the pair of tanks 30, 31.

Each of the pair of tanks 30 and 31 has a tubular shape in which an outer plate 32 and an inner plate 33 are connected and brazed to each other. The tubes 21 are joined to the inner plate 33. The outer plate 32 protrudes outward of the heat exchanger 10 and the inner plate 33 protrudes inward of the heat exchanger 10. Thus, a cross-section of each of the pair of tanks 30, 31 has an elliptical shape. Both ends of each of the pair of tanks 30, 31 in the longitudinal direction are closed by lid members 34, 35.

One of the pair of tanks 30 and 31 is a connecting tank 30. The connecting tank 30 has a side portion provided with the connectors 40, 41 for connecting pipes to the tank 30. The connector 40 corresponds to an inlet through which the refrigerant flows into the connecting tank 30 and is disposed in one side of the tank 30 in the longitudinal direction. The connector 41 corresponds to an outlet through which the refrigerant flows out of the tank 30 and is disposed in the other side of the tank 30 in the longitudinal direction. The joining configurations between the tank 30 and the connectors 40, 41 will be described later. The modulator tank 50 is disposed outside of the other tank 31. The modulator tank 50 collects the refrigerant flowing through the tank 31 and performs gas-liquid separation. The tank 31 and the modulator tank 50 are fluidly connected to each other through a flow passage.

In the heat exchanger 10, the refrigerant flows into the tank 30 through the connector 40 and further flows through the tubes 21 while changing a flow direction. Thus, the fluid exchanges heat with external air and is condensed to be a liquid. The condensed refrigerant flows into the modulator tank 50 and is separated into a gas-phase and a liquid-phase in the modulator tank 50. The liquid-phase refrigerant is discharged to the tubes 21 and further cooled. Then, the liquid-phase refrigerant flows out of the heat exchanger 10 through the connector 41 that is connected to the tank 30. The heat exchanger 10 according to the present embodiment includes the modulator tank 50 and constitutes a subcooling cycle. However, the heat exchanger 10 may be a heat exchanger that does not include the modulator tank 50 and constitutes a receiver cycle. In this case, instead of the modulator tank 50, a receiver tank may be provided at a position downstream of the heat exchanger 10.

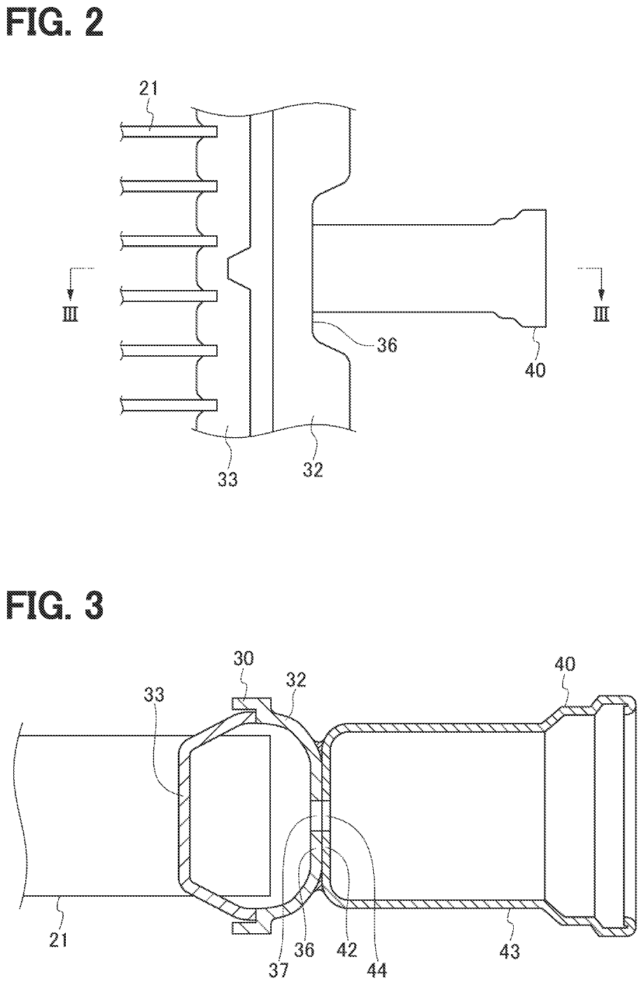

Next, with reference to FIGS. 2 to 5, joining configurations between the tank 30 and the connectors 40 and 41 will be described in detail. Since the connector 40 and the connector 41 can have the same configuration, the connector 40 will be described here as an example.

FIG. 2 is a diagram illustrating the joining configuration between the tank 30 and the connector 40 viewed in the same direction as FIG. 1. As shown in FIG. 2, a part of the outer plate 32, which is a side portion of the tubular tank 30, forms a flat surface 36 in an area to which the connector 40 is connected. The flat surface 36 has a flat shape extending in the longitudinal direction of the tank 30. The flat surface 36 is formed on a part of the side portion of the tank 30 that has a curved shape, so that the connector 40 can be stably joined to the tank 30. The flat surface 36 may be formed by making a recess on a part of the outer plate 32, for example, by performing press-processing on the outer plate 32 of the tank 30.

The connector 40 has a tubular shape that opens on a side where the pipe is inserted. As shown in FIG. 3, the connector 40 has a facing surface 42 that faces the flat surface 36 of the tank 30 and a side surface 43 that surrounds an outer circumference of the facing surface 42. The facing surface 42 has a circular shape and defines a hole 44 at a position corresponding to the inlet 37 of the tank 30. The refrigerant supplied from the pipe that is inserted into the connector 40 flows into the tank 30 through the hole 44 and the inlet 37.

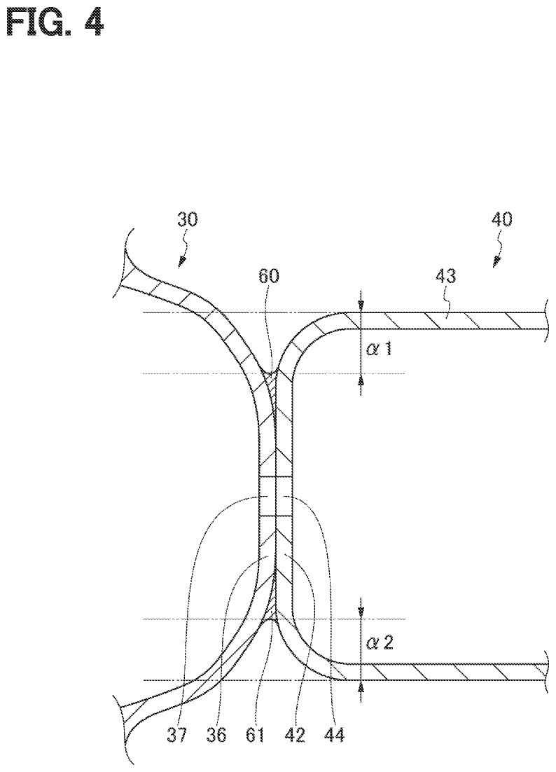

FIG. 4 is a partial enlarged view of the joint region between the tank 30 and the connector 40 in the cross-sectional view shown in FIG. 3. The connector 40 is joined to the flat surface 36 of the tank 30 such that at least a part of the facing surface 42 of the connector 40 extends beyond the flat surface 36 in a lateral direction of the tank 30. The lateral direction of the tank 30 is a direction perpendicular to the longitudinal direction of the tank 30 in a plan view of the flat surface 36. As shown in FIG. 4, the facing surface 42 of the connector 40 in the present embodiment extends beyond both ends of the tank 30 in the lateral direction of the tank 30 by an extending amount α1 and an extending amount α2. The extending amount α1, α2 is, for example, a distance between the outer side surface 43 of the connector 40 and a position at which fillet of wax 60, 61 connecting between the tank 30 and the connector 40 is constricted inward the most. That is, in the heat exchanger 10, the extending amounts α1, α2>0 is satisfied.

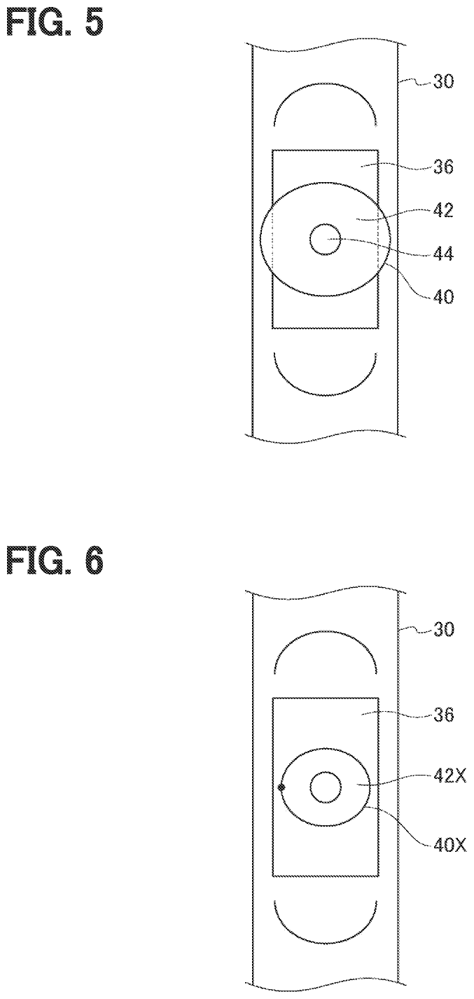

FIG. 5 is a diagram illustrating a positional relationship between the flat surface 36 and the facing surface 42 of the connector 40 in a plan view of the flat surface 36 of the tank 30. In FIG. 5, the facing surface 42 of the connector 40 is shown but an illustration of the main body of the connector 40 is omitted. As shown in FIG. 5, in the plane view of the flat surface 36, the facing surface 42 of the connector 40 is within the flat surface 36 in the longitudinal direction of the tank 30 and extends beyond the flat surface 36 in the lateral direction of the tank 30. The effect obtained by the configuration in which the facing surface 42 of the connector 40 extends beyond the flat surface 36 will be described with reference to a comparative example shown in FIG. 6.

In the heat exchanger of the comparative example shown in FIG. 6, a facing surface 42X of a connector 40X does not extend beyond the flat surface 36 of the tank 30 in the lateral direction and is arranged within the flat surface 36 of the tank 30. In the heat exchanger of the comparative example, when high-temperature and high-pressure refrigerant is supplied into the tank, pressure is applied to an inner side of the tank 30, so that the flat surface 36 of the tank 30 is likely to be deformed outward. Since the connector 40X that is joined to the flat surface 36 restricts deformation of the flat surface 36, stress can be concentrated on a point at an edge of the joint portion between the tank 30 and the connector 40X (see a black point in FIG. 6). When the heat exchanger is used repeatedly in such a state, the tank 30 may be damaged from the point where stress is concentrated.

In the heat exchanger 10 of the present embodiment, a portion of the facing surface 42 of the connector 40 extends beyond the flat surface 36 of the tank 30 in the joint configuration between the connector 40 and the tank 30. In this case, when pressure is applied to the inner side of the tank 30, stress is applied along lines where an outer edge of the flat surface 36 overlap with the facing surface 42 of the connector 40 (see broken lines in FIG. 5). That is, in the present disclosure, since the stress is dispersed linearly, the stress concentration is relaxed as compared with a configuration in which the facing surface 42 of the connector 40 does not extend beyond the flat surface 36 of the tank 30. In the heat exchanger 10, for example, stress concentration on the tank 30 can be reduced with a relatively simple configuration without increasing the plate thickness of the tank 30 or inserting a reinforcing plate between the tank 30 and the connector 40. Thus, it is possible to avoid increase in the number of parts and work steps.

In this embodiment, the facing surface 42 of the connector 40 is joined to the flat surface 36 of the tank 30 such that at least a part of the facing surface 42 of the connector 40 extends beyond both ends of the flat surface 36 in the lateral direction of the tank 30.

According to this preferred embodiment, the both ends of the facing surface 42 of the connector 40 in the lateral direction extend beyond the flat surface 36 of the tank 30 in the joint configuration between the connector 40 and the tank 30. Thus, stress concentration can be reduced on both sides of the flat surface 36.

In the present embodiment, the tank 30 includes the inner plate 33 to which the multiple tubes 21 are joined and the outer plate 32 on which the flat surface 36 is formed.

According to this preferred embodiment, since the tank 30 is formed by connecting the two plates, press-processing of the tank 30 for forming the flat surface 36 is easier as compared with press-processing of an integrally formed tank.

In this embodiment, the heat exchanger 10 is a condenser that cools and condenses the refrigerant.

Into the condenser, high-temperature and high-pressure gas-phase refrigerant is repeatedly supplied each time it is used, that is, a relatively high pressure is repeatedly applied to the tank 30. Thus, according to this preferred embodiment, the effect of reducing the stress concentration on the tank 30 is high. It should be noted that the heat exchanger 10 is not limited to a condenser, and the heat exchanger 10 may be, for example, a radiator or the like.

In the above-described embodiment, both sides of the facing surface 42 of the connector 40 are evenly extend beyond the flat surface 36 in the lateral direction of the tank 30. However, the extending amount α1 is not necessarily equal to the extending amount α2 and only either one of the ends of the facing surface 42 may extend beyond the flat surface 36.

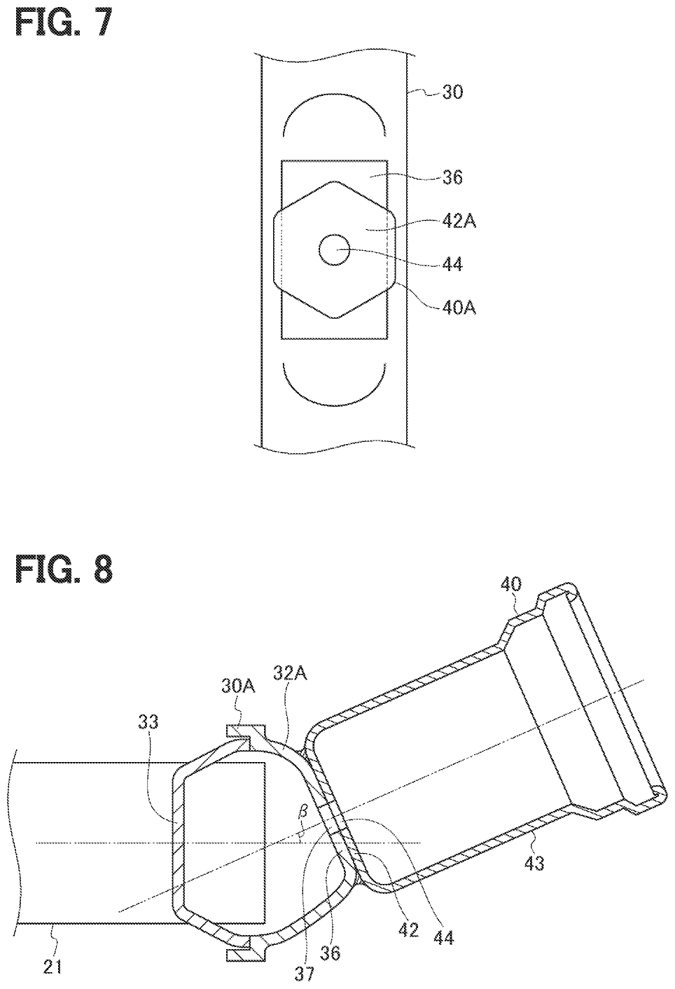

Next, with reference to FIG. 7, a joint configuration of a tank and a connector in a heat exchanger of a modification from the first embodiment of the present disclosure will be described. In the following modifications, the same elements as those in the above embodiment are designated by the same reference numerals, and the description thereof will be omitted. Further, in the following modifications, the description of portions common to the above-described embodiment will be omitted, and only different portions will be described. In particular, the same effects caused by the same configuration will not be mentioned for each modification.

As shown in FIG. 7, a facing surface 42A of a connector 40A in this modification has a hexagonal shape in the plan view of the flat surface 36 of the tank 30. Similar to the connector 40, at least a portion of the facing surface 42A of the connecter 40A extends beyond the both ends of the flat surface 36 of the tank 30 in the lateral direction, so that the same effects as those of the above embodiment can be obtained. As described above, the shape of the facing surface of the connector is not limited to a circle, and may be any other shape.

Next, with reference to FIG. 8, a joint configuration between a tank and a connector in a heat exchanger of another modification from the first embodiment of the present disclosure will be described. As shown in FIG. 8, in this modification, a direction in which the connector 40 is joined to the tank 30 is different from that in the embodiment shown in FIG. 3.

In this modification, a flat surface 36 of an outer plate 32A of a tank 30A is arranged so that its normal line is tilted by an angle β with respect to an extending direction of the tube 21. The connector 40 is joined to the flat surface 36 so that both ends of the facing surface 42 of the connector 40 extend beyond the flat surface 36, as in the above-described embodiment. That is, an opening direction of the connector 40 is also tilted by the angle β with respect to the extending direction of the tube 21. As described above, the direction in which the connector 40 is joined to the tank may be parallel to, may be tilted relative to, or may be perpendicular to the extending direction of the tube 21. A cross-sectional shape of the tank 30A may be variously changed depending on the direction in which the connector 40 is joined to the tank 30A.

The present embodiments have been described above with reference to concrete examples. However, the present disclosure is not limited to those specific examples. Those specific examples that are appropriately modified in design by those skilled in the art are also encompassed in the scope of the present disclosure, as far as the modified specific examples have the features of the present disclosure. Each element included in each of the specific examples described above and the arrangement, condition, shape, and the like thereof are not limited to those illustrated, and can be changed as appropriate. The combinations of elements included in each of the above described specific examples can be appropriately modified as long as no technical inconsistency occurs.

What is claimed is:

1. A heat exchanger comprising:
a plurality of tubes stacked with each other in a stacking direction;
a pair of tanks disposed at both ends of the plurality of tubes, each of the pair of tanks having a longitudinal direction along the stacking direction, at least one of the pair of tanks being a connecting tank; and
a connector disposed in a side portion of the connecting tank to fluidly connect a pipe to the connecting tank, wherein
the connecting tank has a tubular shape and includes a flat surface on the side portion,
the connector includes a facing surface facing the flat surface of the connecting tank,
the facing surface of the connector is joined to the flat surface such that at least a portion of the facing surface extends beyond the flat surface in a lateral direction of the connecting tank,
the connector has a tubular shape having a center axis that is perpendicular to the facing surface, and
the connector defines an opening at an opposite side that is opposite to the facing surface.

2. The heat exchanger according to claim 1, wherein
the at least a portion of the facing surface of the connector extends beyond both ends of the flat surface in the lateral direction of the connecting tank.

3. The heat exchanger according to claim 1, wherein
the connecting tank includes an inner plate to which the plurality of tubes are connected and an outer plate including the flat surface.

4. The heat exchanger according to claim 1, wherein
the heat exchanger is a condenser configured to cool and condense a refrigerant.
